(19) United States
(12) Patent Application Publication
(10) Pub. No.: US 2015/0132173 A1
(43) Pub. Date: May 14, 2015

(54) LASER PROCESSING OF A BED OF POWDERED MATERIAL WITH VARIABLE MASKING

(71) Applicant: Siemens Energy, Inc., Orlando, FL (US)

(72) Inventors: Gerald J. Bruck, Oviedo, FL (US); Ahmed Kamel, Orlando, FL (US)

(21) Appl. No.: 14/533,185

(22) Filed: Nov. 5, 2014

Related U.S. Application Data
(60) Provisional application No. 61/902,829, filed on Nov. 12, 2013.

(51) Int. Cl. B23K 26/34; B23K 26/30; B23P 6/00; B23K 26/06; B22F 3/105; B22F 3/00

(52) U.S. Cl. CPC B23K 26/345; B22F 3/1055; B22F 3/003; B23P 6/00; B23K 26/0656; B23K 26/422; B33Y 10/00
USPC 419/1; 425/78; 219/76.14

(57) ABSTRACT

An additive manufacturing apparatus (10) and process including selectively heating a processing plane of a bed of powdered material (14) that includes a powdered metal material (14′), and may also include a powdered flux material (14″). The heating may be accomplished by directing an energy beam, such as a laser beam (20), toward a processing plane (27) of the bed. One or more masking elements (61, 62) are disposed between a source (18) of the beam and the processing plane; and the masking elements are variable to change a beam pattern at the processing plane according to a predetermined shape of a component (22) to be formed or repaired.

### CROSS-REFERENCE TO RELATED APPLICATIONS

This application claims the benefit of the 12 Nov. 2013, filing date of U.S. provisional application No. 61/902,829 (attorney docket number 2013P09947US), the entire contents of which are incorporated herein by reference.

### FIELD OF THE INVENTION

This invention relates generally to the field of casting, forming or repairing metal components and parts from a bed of powdered metals. More specifically, this invention relates to using a static or fluidized bed of powdered material to cast or repair parts wherein the powdered material is composed of superalloy metals and other materials.

### BACKGROUND OF THE INVENTION

Welding processes vary considerably depending upon the type of material being welded. Some materials are more easily welded under a variety of conditions, while other materials require special processes in order to achieve a structurally sound joint without degrading the surrounding substrate material.

Common arc welding generally utilizes a consumable electrode as the feed material. In order to provide protection from the atmosphere for the molten material in the weld pool, an inert cover gas or a flux material may be used when welding many alloys including, e.g., steels, stainless steels, and nickel based alloys. Inert and combined inert and active gas processes include gas tungsten arc welding (GTAW) (also known as tungsten inert gas (TIG)) and gas metal arc welding (GMAW) (also known as metal inert gas (MIG) and metal active gas (MAG)). Flux protected processes include submerged arc welding (SAW) where flux is commonly fed, electroslag welding (ESW) where the flux forms an electrically conductive slag, flux cored arc welding (FCAW) where the flux is included in the core of the electrode, and shielded metal arc welding (SMAW) where the flux is coated on the outside of the filler electrode.

The use of energy beams as a heat source for welding is also known. For example, laser energy has been used to melt pre-placed stainless steel powder onto a carbon steel substrate with powdered flux material providing shielding of the melt pool. The flux powder may be mixed with the stainless steel powder or applied as a separate covering layer. To the knowledge of the inventors, flux materials have not been used when welding superalloy materials.

It is recognized that superalloy materials are among the most difficult materials to weld due to their susceptibility to weld solidification cracking and strain age cracking. The term “superalloy” is used herein as it is commonly used in the art; i.e., a highly corrosion and oxidation resistant alloy that exhibits excellent mechanical strength and resistance to creep at high temperatures. Superalloys typically include a high nickel or cobalt content. Examples of superalloys include alloys sold under the trademarks and brand names Hastelloy, Inconel alloys (e.g., IN 738, IN 792, IN 939), Rene alloys (e.g., Rene N5, Rene 80, Rene 142), Haynes alloys, Mar M, CM 247, CM 247 LC, C263, 718, X-750, ECY 768, 282, X45, PWA 1483 and CMSX (e.g., CMSX-4) single crystal alloys.

Weld repair of some superalloy materials has been accomplished successfully by preheating the material to a very high temperature (for example to above 1600° F. or 870° C.) in order to significantly increase the ductility of the material during the repair. This technique is referred to as hot box welding or superalloy welding at elevated temperature (SWET) weld repair and it is commonly accomplished using a manual GTAW process. However, hot box welding is limited by the difficulty of maintaining a uniform component process surface temperature and the difficulty of maintaining complete inert gas shielding, as well as by physical difficulties imposed on the operator working in the proximity of a component at such extreme temperatures.

Some superalloy material welding applications can be performed using a chill plate to limit the heating of the substrate material; thereby limiting the occurrence of substrate heat affects and stresses causing cracking problems. However, this technique is not practical for many repair applications where the geometry of the parts does not facilitate the use of a chill plate.

FIG. 9 is a conventional chart illustrating the relative weldability of various alloys as a function of their aluminum and titanium content. Alloys such as Inconel® IN718 which have relatively lower concentrations of these elements, and consequentially relatively lower gamma prime (strengthening constituent) content, are considered relatively weldable, although such welding is generally limited to low stress regions of a component. Alloys such as Inconel® IN939 which have relatively higher concentrations of these elements are generally not considered to be weldable, or can be welded only with the special procedures discussed above which increase the temperature/ductility of the material and which minimize the heat input of the process. A dashed line 80 indicates a recognized upper boundary of a zone of weldability. The line 80 intersects 3 wt. % aluminum on the vertical axis and 6 wt. % titanium on the horizontal axis. Alloys outside the zone of weldability are recognized as being very difficult or impossible to weld with known processes, and the alloys with the highest aluminum content are generally found to be the most difficult to weld, as indicated by the arrow.

It is also known to utilize selective laser melting (SLM) or selective laser sintering (SLS) to melt or partially melt/bond (sinter) a thin layer of superalloy powder particles onto a superalloy substrate. The melt pool is shielded from the atmosphere by applying an inert gas, such as argon, during the laser heating. These processes tend to trap the oxides (e.g., aluminum and chromium oxides) that are adherent on the surface of the particles within the layer of deposited material, resulting in porosity, inclusions and other defects associated with the trapped oxides. Post process hot isostatic pressing (HIP) is often used to collapse these voids, inclusions and cracks in order to improve the properties of the deposited coating. The application of these processes is also limited to horizontal surfaces due to the requirement of pre-placing the powder.

Laser microcladding is a 3D-capable process that deposits a small, thin layer of material onto a surface by using a laser beam to melt a flow of powder directed toward the surface. The powder is propelled toward the surface by a jet of gas, and when the powder is a steel or alloy material, the gas is argon or other inert gas which shields the molten alloy from atmospheric oxygen. Laser microcladding is limited by its low deposition rate, such as on the order of 1 to 6 cm³/hr. Furthermore, because the protective argon shield tends to dissipate before the clad material is fully cooled, superficial oxidation and nitridation may occur on the surface of the deposit, which is problematic when multiple layers of clad material are necessary to achieve a desired cladding thickness.

For some superalloy materials in the zone of non-weldability there is no known commercially acceptable welding or repair process. Furthermore, as new and higher alloy content superalloys continue to be developed, the challenge to develop commercially feasible joining processes for superalloy materials continues to grow.

With respect to original equipment manufacturing (OEM), selective laser sintering and selective laser melting of a static bed of powdered metal alloys have been suggested as alternative manufacturing processes; however, components produced using these processes are with limited productivity and quality. In addition, processing time remains an issue because parts are formed by very thin incrementally deposited layers by translating the part vertically downward to introduce (by a mechanical wiper or scraper) a new layer of powder for melting. Moreover, the interface between incrementally processed layers or planes is subject to defects and questionable physical properties.

Casting a part from a fluidized bed of a powdered metal is disclosed in U.S. Pat. No. 4,818,562 (the '562 patent), the content of which is fully incorporated herein by reference. The '562 patent generally discloses the introduction of a gas into a bed of powdered metal and selectively heating regions of the powdered metal using a laser. In particular, the '562 patent discloses the introduction of an inert gas such argon, helium, and neon. The inert gas is provided to displace any atmospheric gases that may react with the hot or molten metal to form metal oxides, which may compromise the integrity of a component. The '562 patent also discloses that gas used to fluidize the powder may be a reactive gas such as methane or nitrogen; however, without introduction of the inert or other shielding mechanism, the risk of that the constituents of the molten metal will react with available elements remains. Moreover, system and process disclosed in the '562 patent is limited to processing the surface of the bed with a part or component submerged in the bed.

A limitation to SLM/SLS processes is processing time. While such additive manufacturing processes have been used for prototype manufacturing of land-based and aero-turbine engines these processes have not been extended to production manufacturing of high temperature parts for these engines. Laser cladding of complex geometries such as airfoils of turbine blades and vanes requires precise programming and hard fixturing to ensure tracking.

When forming an airfoil a laser beam may be used to track a convex profile of the airfoil; however, when the laser beam encounters the concave side, the beam misses the location of processing because of lateral distortion induced by heating of the convex edge before the concave edge is processed. Similar lateral movement would be expected if the concave edge were processed before the convex edge. This lateral movement can be avoided if both the concave and convex edges are processed simultaneously. Thermal expansion and contraction of the metal alloy is balanced on both the concave and convex edges in the process direction. However, such simultaneous processing along two tracks complicates optics programming and laser power coordination; and, the speed of on-off switching of the beam and/or deceleration-acceleration of the mirrors is limited.

### BRIEF DESCRIPTION OF THE DRAWINGS

The invention is explained in the following description in view of the drawings that show:

FIG. 1 is a schematic illustration of a system and process for repair or manufacture of a component using a fluidized bed of powdered material including powdered metal and powdered flux materials and masking elements disposed between a top surface of the fluidized bed and an energy beam scanning system.

FIG. 2 is a schematic illustration of the system of claim 1 wherein the masking elements have been moved according to a predetermined shape of a component to be formed.

FIG. 3A is a schematic illustration of a masking element for an airfoil of a turbine blade or vane, wherein the energy beam is scanning a bed below the masking element.

FIG. 3B is a schematic illustration of a masking element for an airfoil of a turbine blade or vane, wherein the energy beam is scanning a bed below the masking element and a width dimension of the beam is adjusted.

FIG. 4 is a schematic illustrating of an embodiment including multiple masking elements aligned side by side and arranged to include an optically transmissive portion in a cross-sectional shape of an airfoil for a turbine blade.

FIG. 5 is a schematic illustration of the process showing a layer of slag formed over a deposited metal substrate.

FIG. 6 is a top view of the system and process including a slag removal tool for removal of the slag layer.

FIG. 7 is a schematic illustration of a slag removal tool positioned for removal of a slag layer.

FIG. 8 illustrates an energy beam overlap pattern.

FIG. 9 is a prior art chart illustrating the relative weldability of various superalloys.

### DETAILED DESCRIPTION OF THE INVENTION

FIG. 1 illustrates an additive manufacturing system and process distinctly different than SLM and SLS systems described above. An additive manufacturing apparatus 10 includes a chamber 12 filled with bed of powdered material 14 (bed or powdered bed) including powdered metal material 14′ and powdered flux material 14″. The bed of powdered material 14 may be fluidized by introducing a gas through one or more tubes 16, which are in fluid communication with a plenum 17 at the bottom of the chamber 12. A diffuser plate 19 is provided to separate the plenum 17 from the bed 14 and generally uniformly distributes the fluidizing gas in the chamber 12. An example of such diffuser plate is 20 micron, 46 percent porosity, 3 mm (⅛ inch) thick, sintered sheet material of type 316L stainless steel available from Mott Corporation.

As one skilled in the art will appreciate, the flow rate of the fluidizing gas must be controlled to adequately fluidize the bed 14 so that a sufficient amount of powdered material 14 will settle for processing. Such flow rate control will depend on a number of inter-related parameters including volume of the bed 14 and/or chamber 12, density of the powdered material 14, particle size, etc. For example, the flux material 14″ may be coarser than the metal powder to enhance consistency and uniformity of fluidization of both metal and flux particles. That is, flux material 14″ tends to be less dense than the metal material 14′; therefore, small metal particles may be better matched in terms of fluidizing larger, but less dense flux particles. Accordingly, the fluidizing medium flow rate can uniformly fluidize both the powdered flux material 14″ larger particles and powdered metal material 14′ smaller particles.

The shape and size of the resulting laser-processed component 22 can also affect the ability to adequately fluidize the bed 14 so that a sufficient amount of powdered material 14 is available for laser processing. Whereas fluidizing a powder around a structure of narrow cross section (i.e., skeleton like) may be effective in distributing powder over the process plane 27, in some instances fluidizing over a broad substrate may not be fully effective because the fluidizing medium cannot penetrate the bulk of a component 22 to fluidize powder over its broader surface. Therefore, in some embodiments the process of fluidization is enhanced by vibrating the component 22 itself to induce spreading of the powdered material 14 over the broader surface of the component 22. Such mechanical vibratory energy may be produced using a transducer (not shown) that may be directly or indirectly connected to the component 22. In some non-limiting embodiments, for example, mechanical vibratory energy may be applied indirectly to the component 22 using a transducer in mechanical communication with the piston 13.

It is further recognized that the metal material 14′ and the flux material 14″ may alternately be combined in composite particles of consistent density and mesh range such that they fluidize in a consistent fashion. For example, such composite particles may be in the form of particles comprising a core surrounded by a metallic layer, wherein the core comprises the flux material 14″ and the metallic layer comprises the metal material 14′. In other non-limiting examples such composite particles may be in the form of a fused material comprising the metal material 14′ and the flux material 14″, wherein the metal material 14′ and the flux material 14″ are randomly distributed and randomly oriented within the fused material. In some composite materials a volume ratio of the flux material 14″ to the metal material 14′ may range from about 30:70 to about 70:30. In other composites the volume ratio of the flux material 14″ to the metal material 14′ may range from about 40:60 to about 60:40, or from about 45:55 to about 55:45. In some embodiments the volume ratio of the flux material 14″ to the metal material 14′ is about 50:50.

A scanning system 18 then directs an energy beam such as laser beam 20 toward the fluidized powdered bed 14 to heat (melt, partially melt or sinter) and solidify regions of the powder to form a portion of component 22. The component 22 is formed on a platen 24 that is operatively connected to a fabrication piston 13 that moves downward to allow fluidized powdered material 14 to settle on a previously formed or deposited metal substrate. The energy beam 20 then selectively scans the bed of powdered material 14 at those areas where the powdered material 14 has settled on and/or is fluidized above a previously formed substrate or deposited metal.

The embodiment described thus far is distinct from conventional SLM/SLS in that the powder bed is not static, the process is continuous not incremental, inert gas is not mandatory as the flux can provide shielding and masking provides for considerable process flexibility and speed.

While the apparatus 10 and process are described herein in connection with the use of a fluidized bed, the below-described masking techniques and masking elements can be used with a static bed of powdered material that includes powdered metal material and/or powdered flux material. In such an embodiment, the additive manufacturing process would be performed incrementally to supply powdered material over a recently deposited metal layer to develop or repair a component.

Relative movement between the laser beam 20 and component 22 may be controlled in accordance with a predetermined pattern or shape of the component 22. In an embodiment the scanning system 18 includes one or more controllers 26, or software, that controls movement of the laser beam 20 to follow a predetermined pattern or shape of the component 22, including dimensions thereof, along horizontal X and Y axes. Such movement may include movement of the beam to selectively scan a surface 27 of the bed, moving the laser beam according to a specific pattern, the below describing rastering technique and/or known masking techniques. In addition, while the embodiment shown in FIG. 1 includes a single laser beam 20, it is possible to combine several laser beams, or the beam from a single laser can be split or rapidly time shared so that multiple portions of a given part or multiple identical parts can be simultaneously formed.

The platen 24 may also be adapted to move vertically downward and upward to account for the Z axis of the predetermined pattern or shape of the component 22. Alternatively, or in addition to, a surface in the chamber 12 on which the component 22 is formed may be moveable along the horizontal X and Y axes. For example, the chamber 12 may include an X-Y translation stage and controller to control movement of the component 22 relative to the laser beam 20.

When used in connection with the manufacture of a component, the component 22 may be formed on a support plate 29, which may have a metal composition similar to that of the component 22 to be formed. For example, the plate 29 may be composed of a nickel based superalloy when developing components for a turbine engine. When the manufacture of the component 22 is completed, the plate 29 is separated from the component 22 using known metal cutting techniques.

An advantage of the additive manufacturing apparatus and processes having a fluidized bed of powdered material 14 described herein over static bed SLS and/or SLM processes, when used with or without the below-described masking elements, is that parts or portions of the component 22 may extend above the processing plane 27 while portions in the bed 14 at the processing plane 27 are formed or repaired. For example, an airfoil of a turbine blade or vane may extend above the processing plane 27, while the platform is positioned within the bed at the processing plane for development or repair. Accordingly, complex surfaces of turbine components such as Z-notches, blade platforms and/or virtually any part of a turbine blade the blade tip can be processed as remaining portions of the component are above the bed processing plane.

In contrast SLM and SLS additive processes require the mechanical, incremental addition of powdered material between consecutive laser beam applications wherein a rake type device or wiper applies powdered material across previously formed layers. The above-described fluidized bed provides an even distribution and application of powdered material 14 without the need of the incremental raking of powdered material; therefore portions of the component may be above the processing plane while other parts of the component being repaired are below or at the processing plane.

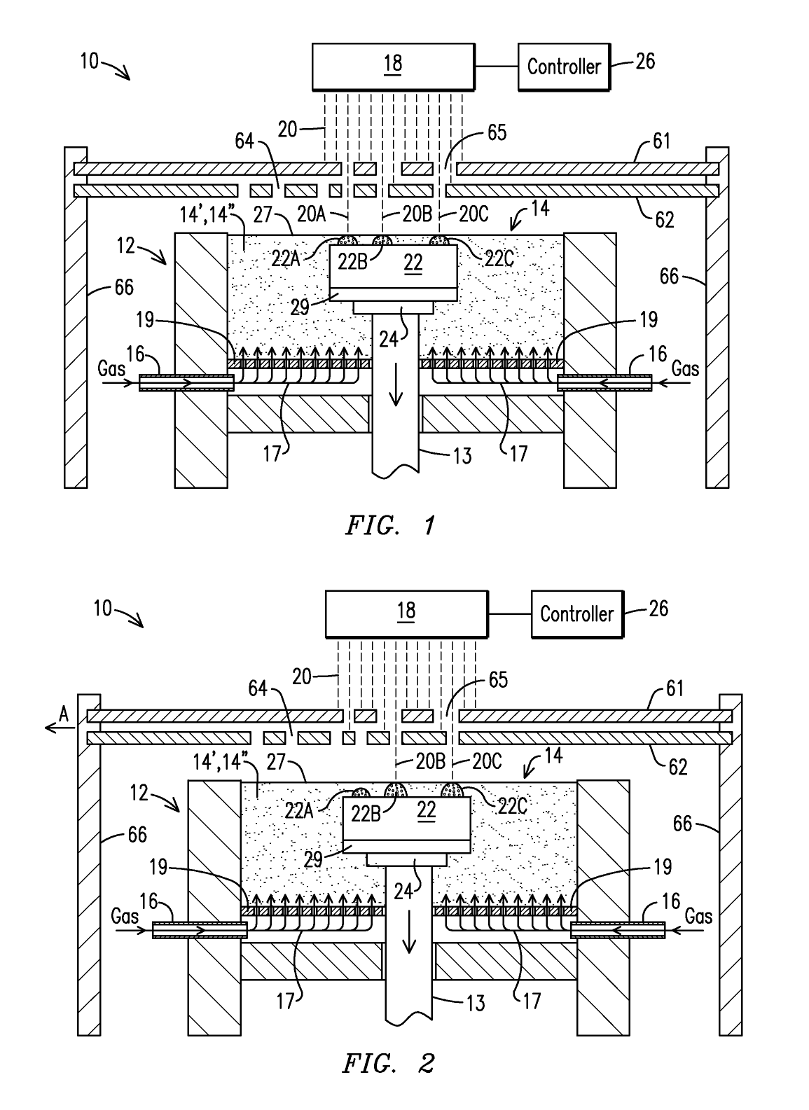

In an embodiment one or masking elements may be disposed between a source of the beam 20 and a processing plane of the bed 14, and the mask elements are operable to change a beam pattern at the processing plane in accordance with a predetermined shape of the component 22. As further shown in FIGS. 1 and 2, a plurality of masking elements 61, 62 may be disposed between the scanning system 18 or beam 20 and the surface 27 (also referred to as the “processing plane”).

Each of the masking elements 61, 62 may include one or more optically transmissive portions 64, 65, respectively. Such optically transmissive portions 64, 65 may be in the form of hollow (empty) portions of the masking elements 61, 62, or may be in the form of transparent or translucent materials contained in the masking elements 61, 62 that partially or fully transmit the energy beam 20, or may be in the form of filtered portions of the masking elements 61, 62 containing (for example) fine hole patterns in which an amount of the energy beam 20 passing through a filtered portion depends on the size and density of holes contained in the filtered portion. Suitable transparent materials may include materials that transmit photons having the same wavelengths as the energy beam 20, and optionally having a melting point higher than a melting temperature of the alloy being laser processed. Such transparent materials may include, for example, materials that are transmissive to ytterbium lasers and/or CO₂ lasers such as borosilicate glasses (0.35-2 μm), phosphate glasses (Pb+Fe, Na+Al), silicas (0.185-2.1 μm) (e.g., quartz), alumina materials (0.15-5 μm) (e.g., sapphire), magnesium fluoride materials (0.12-6 μm), calcium fluoride materials (0.18-8 μm), barium fluoride materials (0.2-11 μm), zinc selenide materials (0.6-16 μm), ZBLAN glasses (0.3-7 μm), and transmissive metalloids such as silicon (3-5 μm) and germanium (2-16 μm), to name a few. Such transparent materials may be doped with laser absorbing materials to create semi-transparent or translucent materials. Use of transparent or translucent materials may be advantageous in some embodiments because (unlike hollow (empty) portions) solid translucent materials may provide physical support to other portions of masking elements.

In FIGS. 1 and 2 the masking elements 61, 62 are supported in a “stacked” configuration, with masking element 61 positioned over the masking element 62, and are mounted to support members 66. These support members 66 may have or are operatively connected to control mechanisms to control movement of the masking elements 61, 62 relative to one another and/or relative to the energy beam 20. The movement is controlled preferably so that the optically transmissive portions 64, 65 can be continuously moved relative to one another in accordance with a predetermined shape of the component 22.

As shown in FIG. 1 beam sections 20A, 20B and 20C are transmitted through optically transmissive portions of the masking elements 61, 62. The beam sections 20B and 20C are partially blocked by masking element 62 so that corresponding component parts 22A, 22B, and 22C are simultaneously formed. With respect to FIG. 2, the masking element 61 has been laterally moved in the direction of arrow “A”, so that beam section 20 is blocked by masking element 62; however, beam sections 20B, 20C are transmitted through aligned optically transmissive portions to selectively scan the powdered material 14. That is, the masking element 61 is moved to change the beam pattern at the processing plane 27. As shown, the platen 24 has been moved downward so that component parts 22B and 22C are formed according to predetermined geometric features or shapes of the component 22. Note, while the beam 20 shown in FIGS. 1 and 2 appears static, the invention is not limited to a static beam and may include an energy beam that is scanned across an area defined by the masking elements 61, 62 and/or the optically transmissive portions 64, 65 of the masking elements that define the geometry of the component 20 or component part to be formed or repaired.

Accordingly, the apparatus and process may incorporate a multidimensional array of masking elements that move laterally and/or can be rotated in a programmed fashion to control the power delivery to specific locations on the processing plane or otherwise selectively scan the processing plane. While the above-described embodiment includes multiple masking elements, the apparatus and process may be configured to include only a single masking element with one or more optically transmissive portions that is moved to change the beam pattern at the processing plane as the platen 24 is lowered to continuously develop the component 221n the embodiments shown in FIGS. 3A and 3B, a masking element 70 is shown including an optically transmissive portion 71 having a cross-sectional geometric shape of an airfoil for a turbine vane or blade. As explained above the transmissive portion 71 may be in the form of a translucent material that partially or fully transmits the energy beam 20, or may be in the form of filtered portions containing (for example) fine hole patterns in which an amount of the energy beam 20 passing through a filtered portion 71 depends on the size and density of holes contained in the filtered portion. In such embodiments the translucent material and/or the filtered portion may provide physical support for a middle portion of the masking element 70. Such a masking element 70, and the masking elements 61, 62 may contain a laser energy tolerant material that is opaque relative to the laser beam 20. Such laser-opaque materials may include graphite or zirconia which are opaque to a wide range of laser beam wavelengths. Copper may also be used, but may be reflective to a laser beam such that the angle at which the laser beam addresses the masking beam should be adjusted to avoid back reflection to the laser optics.

With respect to FIG. 3A, the beam 20 is moved from left to right as indicated by arrow C. As further shown, a width dimension is maintained constant across a processing path so that it is at least as wide as a largest width dimension of the optically transmissive portion 71. Alternatively, a width dimension of the beam 20 may be adjusted as it moves across the processing plane 27 to account for the corresponding width dimension of the airfoil as shown in FIG. 3B. In either embodiment of FIGS. 3A and 3B, the beam 20 may be moved left to right and then right to left to continuously develop an airfoil as platen 24 is moved vertically downward. Such width control may be affected, for example, by using optical adjustments that can change the size of a generally rectangular beam from a diode laser or that can change the width of scanning produced by rastered mirrors used with fiber or other lasers that generate circular beam patterns.

As described above, the apparatus 10 may include a single masking element that is variable and/or moveable to change a beam pattern at the processing plane 27. By way of example, airfoils for a turbine vane or blade may have a subtle twist from the platform to the tip of the blade or vane. Accordingly, the masking element 70 may be pivoted around a central axis “B” as the airfoil is developed.

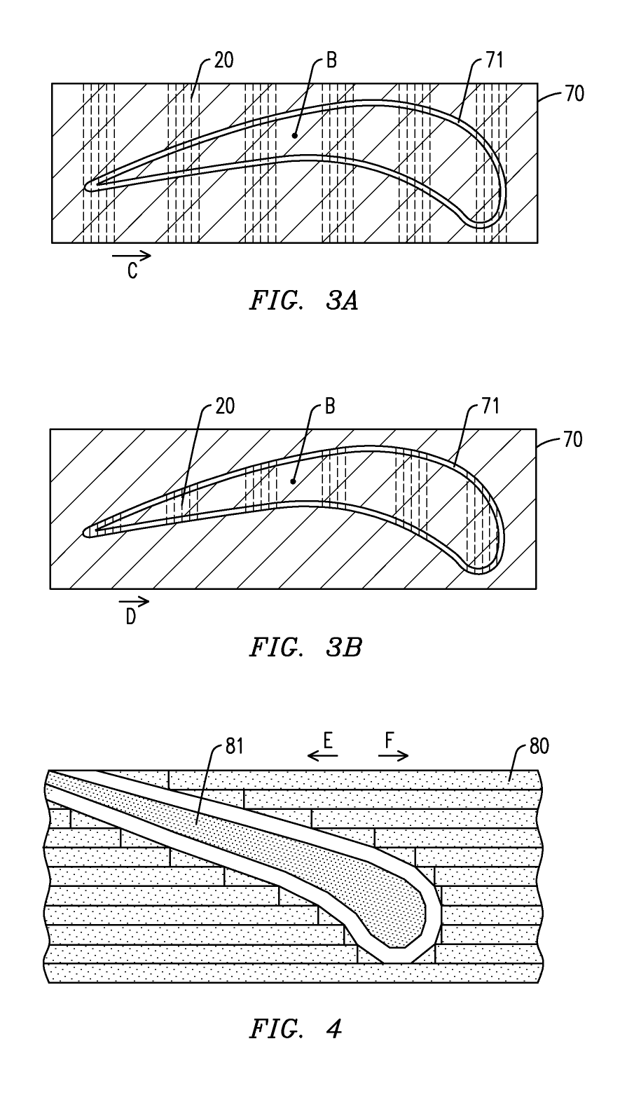

With respect to FIG. 4, an embodiment is shown including a plurality of masking elements 80 that are aligned side-by-side. The masking elements 80 may take the form of graphite rods with beveled ends to achieve a desired component shape or configuration. In this example, the rods or masking elements 80 are operatively connected to a control mechanism to move the masking elements 80 laterally (arrows “E” and “F”) in accordance with a predetermined shape of a component to be formed or repaired. As further shown, a core 81 masking element may be provided to account for a hollow interior of the airfoil, and may be stationary or moveable in accordance with a predetermined shape of the airfoil, component 22.

In yet another embodiment, a masking element may take the form of a liquid crystal display that is programmable to display images including optically transmissive and opaque portions in accordance with a predetermined shape of a component 22.

The energy beam 20 in the embodiments of FIGS. 1-5, may be a diode laser beam having a generally rectangular cross-sectional shape, although other known types of energy beams may be used, such as electron beam, plasma beam, one or more circular laser beams, a scanned laser beam (scanned one, two or three dimensionally), an integrated laser beam, etc. The rectangular shape may be particularly advantageous for embodiments having a relatively large area to be clad; however, the beam may be adaptable to cover relatively small areas such as small distressed regions in need of repair. The broad area beam produced by a diode laser helps to reduce weld heat input, heat affected zone, dilution from the substrate and residual stresses, all of which reduce the tendency for the cracking effects normally associated with superalloy repair and manufacture.

Optical conditions and hardware optics used to generate a broad area laser exposure may include, but are not limited to: defocusing of the laser beam; use of diode lasers that generate rectangular energy sources at focus; use of integrating optics such as segmented mirrors to generate rectangular energy sources at focus; scanning (rastering) of the laser beam in one or more dimensions; and the use of focusing optics of variable beam diameter (e.g., 0.5 mm at focus for fine detailed work varied to 2.0 mm at focus for less detailed work). The motion of the optics and/or substrate may be programmed as in a selective laser melting or sintering process to build a custom shape layer deposit. To that end, the laser beam source is controllable so that laser parameters such as the laser power, dimensions of the scanning area and traversal speed of the laser 20 are controlled so that the thickness of the deposit corresponds to the thickness of the previously formed substrate or that metal is deposited according to the predetermined configuration, shape or dimensions of the component 22.

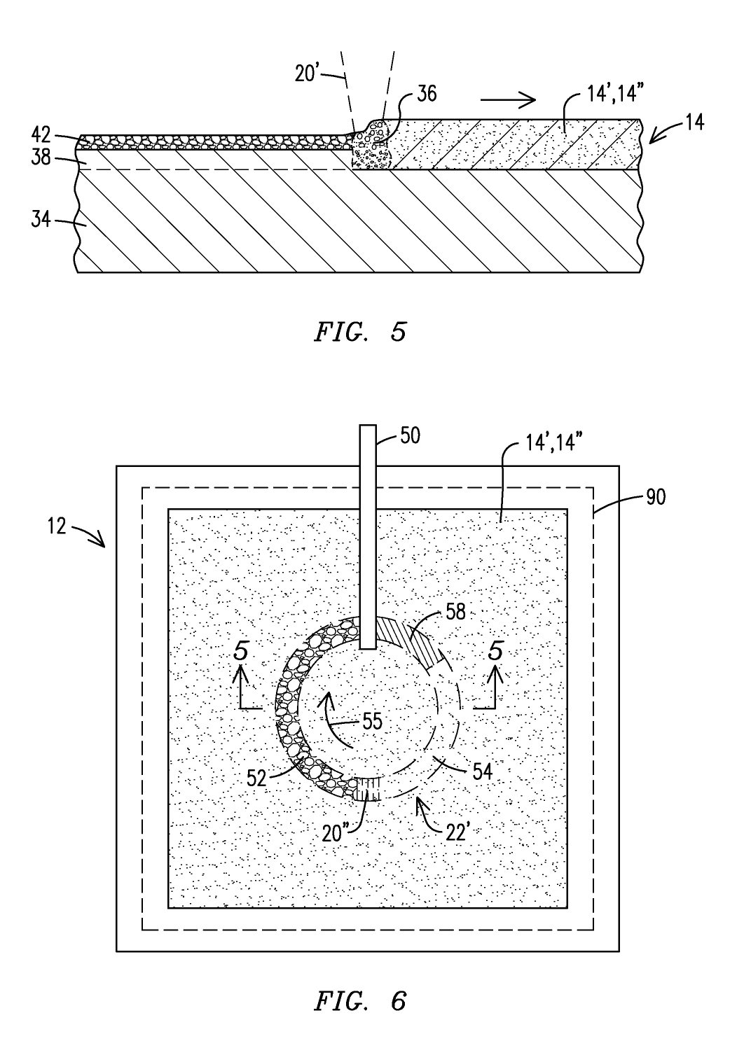

In addition, dimensions of the laser beam 20′ may be controlled to vary according to corresponding dimensions of the component. For example, in FIG. 5 referred to below in more detail, the energy beam 20′ has a generally rectangular configuration. A width dimension of the laser beam 20′ may be controlled to correspond to a changing dimension, such as thickness, of a portion of the component 22. Alternatively, it is possible to raster a circular laser beam back and forth as it is moved forward along a substrate to effect an area energy distribution. FIG. 8 illustrates a rastering pattern for one embodiment where a generally circular beam having a diameter D is moved from a first position 34 to a second position 34′ and then to a third position 34″ and so on. An amount of overlap O of the beam diameter pattern at its locations of a change of direction is preferably between 25-90% of D in order to provide optimal heating and melting of the materials. Alternatively, two energy beams may be rastered concurrently to achieve a desired energy distribution across a surface area, with the overlap between the beam patterns being in the range of 25-90% of the diameters of the respective beams.

Inasmuch as powdered material 14 includes the powdered flux material 14″ a layer of slag forms over a deposited metal when the laser beam 20′ heats and melts the powdered metal 14′ and powdered flux material 14″. FIG. 5 is a schematic illustration of the fluidized powdered material 14, including the powdered metal 14′ and powdered flux material 14″, which includes material 14″ fluidized over and/or some material 14″ having settled on a previously deposited or formed metal substrate 34. Accordingly, when the beam 20′ traverses the powdered material 14, the powdered metal 14′ and powdered flux material 14″ are melted as represented by the molten region 36 and a metal deposit 38 is formed over a previously formed metal deposit or substrate 34 and covered by a layer of slag 42. In an embodiment of the inventive system or process, the layer of slag 42 may be removed after the energy beam 20 has completed a scan of the powdered material 14 to form a metal layer of the component 22. In such an embodiment, component 22 is formed by incrementally depositing or forming metal layers and removing corresponding layers of slag 42.

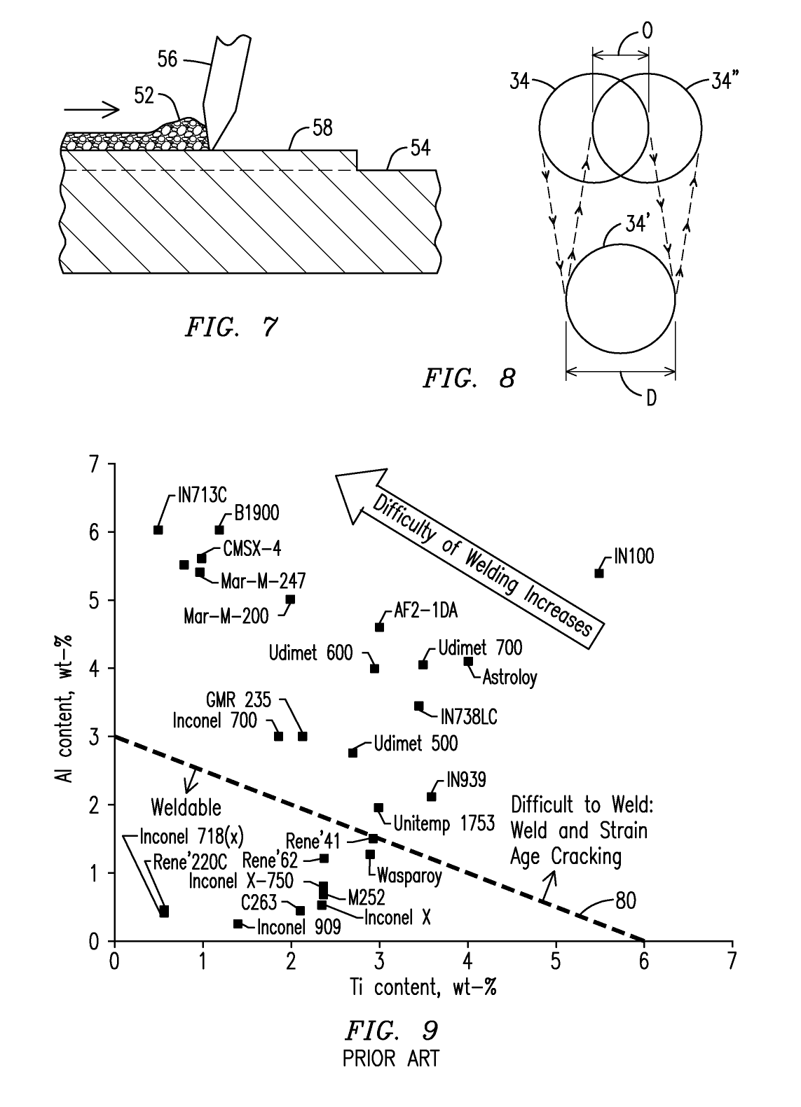

In an embodiment shown in FIGS. 6 and 7, the repair or manufacturing process is performed continuously wherein a layer of slag 52 is removed from recently deposited metal 58 so that fluidized powdered material 14 disposed over a previously deposited metal substrate 54 can be heated, melted and solidified to continuously build up and form the component 22′. The substrate 54 is also sufficiently melted so that fusion may occur between the substrate 54 and recently deposited metal 58, which is the case in the embodiment shown in FIG. 5. As shown the system and process include a slag removal tool 50 that is disposed adjacent to the component 22′ and below masking element 90 (shown in phantom) to remove the layer of slag 52 after the powdered metal 14′ is heated, melted and solidified. For example, the embodiment shown in FIGS. 6 and 7, the component 22′ is rotated relative to the laser beam 20″, which remains generally stationary; however, the laser beam 20″ may be rastering as described above. The component 22′ has a generally cylindrical shape and is rotated in a clockwise direction as represented by arrow 55. The laser beam 20″ selectively scans portions of the powdered material 14 as component 22′ is rotated to heat and melt the powdered metal 14′ and the slag layer 52 is formed over the previously formed metal substrate 54. As known to those skilled in the art, the slag removal tool 50 includes a wedge-shaped head 56 (FIG. 7) to separate the slag layer 52 from the metal 58. In an embodiment, vibrational energy, such as sonic or ultrasonic energy, may be applied to the head 56 to selectively remove the layer of slag 52. In addition, the slag tool 50 is positioned relative to the beam 20 and component 22 so that the layer of slag 52 remains on a recently deposited metal 38 a sufficient time until the solidified and deposited metal is below the temperature of excessive oxidation, which would normally correspond to at least a distance of 55 mm.

The slag 52 is less dense than the powdered metal material 14′ or mixed metal plus powdered flux material 14″, so when the layer of slag 42, 52 is removed in the form of larger particles, the slag 52 may not fluidize as the powdered material, but it will remain toward or at the surface 27 of the bed 14. Slag removal systems such as those disclosed in the commonly owned U.S. application Ser. No. 13/755,157, which is incorporated herein by reference, may be included with embodiments of the subject invention to essentially rake the surface 27 of the bed 14 to remove slag 52 from the chamber 12 and dump the slag 52 into an adjacent bin. The removed slag 52 can then be recycled into reusable powdered flux material. Such slag removal systems may be operatively associated with the scanning system 18 whereby, the surface 27 is raked at predetermined time intervals to remove slag from the chamber 12. Accordingly, the tool 50 shown in FIG. 6 may be moved for a slag removal step. Alternatively, such slag removal systems may be used in place of the slag tool 50 to remove slag layers 42, 52 from recently deposited metal and remove the slag 52 from the chamber 12.

When continuously developing the component 22, the piston 13 and platen 24 may be lowered at a predetermined rate to continuously buildup or develop the component 22. By way of a non-limiting example, the platen 24 including the support plate 29 may be positioned about 4 mm below the surface 27 of the bed 14 so that selective scanning of the bed 14 results in deposit on metal substrate that is about 2 mm in height. When a pass or layer is complete, including heating, melting and solidification of a metal deposit or substrate, the platen 24 is lowered an additional 2 mm so that the recently deposited and solidified metal is disposed about 4 mm below the surface 27 of the bed 14. Of course, if the additive manufacturing process involves the repair of the component 22, then the substrate to be repaired is appropriately positioned relative to the surface 27 of the bed 14. In either instance, the process continues until a substrate of the component is fully developed. This process could also be performed incrementally, where a layer or layers of slag is removed from recently deposited metal layers so a subsequent layer may be formed thereover.

In the event powdered material 14 needs to be added to the chamber 12, known methods to introduce powdered materials, such as those discussed in U.S. Pat. No. 4,818,562 may be used. Another well-known technique to supplement the powdered material 14 of chamber 12 is provided by an apparatus 10 feed bin and a feed roller to move powdered material from the bin to the chamber 12 between scanning steps of the laser beam 20. To that end, the chamber 12 may be equipped with sensors, such as optical-type sensors to detect when the surface 27 of the bed 14 drops below a predetermined level to initiate a sequence for adding powdered material 14. The powdered metal 14′ and component 22, 22′ and substrate may be composed of a nickel-based superalloy having constituent elements such as Cr, Co, Mo, W, Al, Ti, Ta, C, B, Zr and Hf. Both Al and Ti are relatively volatile and both are reactive with oxygen and nitrogen. Accordingly, Al and Ti can be lost during repair or manufacture of a component, especially if a reactive gas such as air is used to fluidize the powdered material 14. It may be necessary to compensate for this loss by enriching the powdered metal 14′ and powdered flux material 14″ with Al and/or Ti and/or titanium aluminide. Most superalloy metal compositions include as much as 3% to about 6% by weight Al and/or Ti, so 3% may be a threshold concentration at which fluidizing gases such as CO₂ or inert gases are used instead of air.

Any of the currently available iron, nickel or cobalt based superalloys that are routinely used for high temperature applications such as gas turbine engines may be joined, repaired or coated with the inventive process, including those alloys mentioned above. Additional applications include wrought nickel based alloys and stainless steels e.g. X, 625, 617 used for combustion component manufacture e.g. combustion rocket swirlers. The bed may be heated using various heaters or techniques, such as a heating coil disposed in the bed to keep the powder metal 14′ and flux 14″ dry and to avoid porosity.

With prior art selective laser heating processes involving superalloy materials, powdered superalloy material is heated under an inert cover gas in order to protect the melted or partially melted powdered metal 14′ from contact with air. In contrast, the embodiment of the present invention illustrated in FIGS. 1-5 utilizes powdered superalloy material 14′ plus powdered flux 14″ as the powder 14, and thus the heating need not be (although it may optionally be) performed under an inert cover gas because melted flux provides the necessary shielding from air. The powder 14 may be a mixture of powdered alloy 14′ and powdered flux 14″, or it may be composite particles of alloy and flux, as described above. In order to enhance the precision of the process, the powder 14 may be of a fine mesh, for example 20 to 100 microns, or a sub-range therein such as 20-80 or 20-40 microns, and the mesh size range of flux particles 14″ may overlap or be the same as the mesh size range of the alloy particles 14′. The flux may also be coarser than the metal powder to enhance consistency and uniformity of fluidization of both metal and flux particles. That is, flux material 14″ tends to be less dense than the metal material 14′; therefore, small metal particles may be better matched in terms of fluidizing larger, but less dense flux particles. Accordingly, the fluidizing medium flow rate can uniformly fluidize both the flux material 14″ larger particles and metal material 14′ smaller particles. The small size of such particles results in a large surface area per unit volume, and thus a large potential for problematic oxides formed on the alloy particle surface. Composite particles may minimize this problem by coating alloy particles with flux material. Furthermore, the melted flux will provide a cleaning action to reduce melt defects by forming shielding gas and by reacting with oxides and other contaminants and floating them to the surface where they form a readily removed layer of slag 42, 52.

The powdered flux 14″ and the resulting slag layer 42, 52 may provide a number of beneficial functions that can improve the chemical and/or mechanical properties of deposited metals 38, 58 and the underlying substrate material 34, 54.

First, the powdered flux 14″ and the resulting slag layer 42, 52 can both function to shield both the region of the melt pool 36 and the solidified (but still hot) melt-processed layer 38, 58 from the atmosphere. The slag floats to the surface to separate the molten or hot metal from the atmosphere, and the powdered flux 14″ may be formulated to produce at least one shielding agent which generates at least one shielding gas upon exposure to laser photons or heating. Shielding agents include metal carbonates such as calcium carbonate (CaCO₃), aluminum carbonate (Al₂(CO₃)₃), dawsonite (NaAl(CO₃)(OH)₂), dolomite (CaMg(CO₃)₂), magnesium carbonate (MgCO₃), manganese carbonate (MnCO₃), cobalt carbonate (CoCO₃), nickel carbonate (NiCO₃), lanthanum carbonate (La₂(CO3)₃) and other agents known to form shielding and/or reducing gases (e.g., CO, CO₂, H₂). The presence of the slag layer 42, 52 and the optional shielding gas can avoid or minimize the need to conduct melt processing in the presence of inert gases (such as helium and argon) or within a sealed chamber (e.g., vacuum chamber or inert gas chamber) or using other specialized devices for excluding air.

Second, the slag layer 42, 52 can act as an insulation layer that allows the resulting melt-processed layer 38 to cool slowly and evenly, thereby reducing residual stresses that can contribute to post weld cracking and reheat or strain age cracking. Such slag blanketing over the deposited metal layer 38, 58 can further enhance heat conduction towards the substrate 34, 54, which in some embodiments can promote directional solidification to form elongated (uniaxial) grains in the deposited metal 38, 58.

Third, the slag layer 42, 52 can help to shape and support the melt pool 36 to keep them close to a desired height/width ratio (e.g., a 1/3 height/width ratio). This shape control and support further reduces solidification stresses that could otherwise be imparted to the deposited metal 38, 58. Along with shape and support, the slag layer 42, 52 can also be produced from a flux composition that is formulated to enhance surface smoothness of the deposited metal 38, 58.

Fourth, the powdered flux 14″ and the slag layer 42, 52 can provide a cleansing effect for removing trace impurities that contribute to inferior properties. Such cleaning may include deoxidation of the melt pool 36. Some flux compositions may also be formulated to contain at least one scavenging agent capable of removing unwanted impurities from the melt pool. Scavenging agents include metal oxides and fluorides such as calcium oxide (CaO), calcium fluoride (CaF₂), iron oxide (FeO), magnesium oxide (MgO), manganese oxides (MnO, MnO₂), niobium oxides (NbO, NbO₂, Nb₂O₅), titanium oxide (TiO₂), zirconium oxide (ZrO₂), and other agents known to react with detrimental elements such as sulfur and phosphorous and elements known to produce low melting point eutectics to form low-density byproducts expected to “float” into a resulting slag layer 42, 52.

Fifth, the powdered flux 14″ and the slag layer 42, 52 can increase the proportion of thermal energy delivered to the surface of the substrate 34, 54. This increase in heat absorption may occur due to the composition and/or form of the flux composition. In terms of composition the flux may be formulated to contain at least one compound capable of absorbing laser energy at the wavelength of a laser energy beam used as the energy beam 20, 20′. Increasing the proportion of a laser absorptive compound causes a corresponding increase in the amount of laser energy (as heat) applied to the substrate surface. This increase in heat absorption can provide greater versatility by allowing the use of smaller and/or lower power laser sources that may be capable of producing a relatively shallower melt pool 36—which may be useful, for example, in laser microcladding. In some cases the laser absorptive compound could also be an exothermic compound that decomposes upon laser irradiation to release additional heat. For example, such an exothermic compound might be contained in composite particles comprising a CO₂ generating core (e.g. including a carbonate) surrounded by aluminum and finally coated with nickel. Nickel coated aluminum powder is in fact proposed as a fuel for propulsion on Mars where CO₂ is plentiful and which provides for such exothermic reaction.

While not required, it may be advantageous in some embodiments to pre-heat the powder 14 and/or the component 22, 22′ prior to a heating step. Post process hot isostatic pressing is also not required, but may be used in some embodiments. Post weld heat treatment of the completed component 22, 22′ may be performed with a low risk of reheat cracking even for superalloys that are outside the zone of weldability as discussed above with regard to FIG. 9.

Reducing the average particle size of the powdered flux 14″ also causes an increase in laser energy absorption (presumably through increased photon scattering within the bed of fine particles and increased photon absorption via interaction with increased total particulate surface area). In terms of the particle size, whereas commercial fluxes generally range in average particle size from about 0.5 mm to about 2 mm (500 to 2000 microns) in diameter (or approximate dimension if not rounded), composite materials in some embodiments of the present disclosure range in average particle size from about 1 to 1000 microns in diameter, or from about 5 to 500 microns, or from about 20 to 100 microns.

The flux material 14″ may also form a molten slag that is optically transmissive. That is when a slag layer/material is formed over a deposited metal layer the slag material is optically transmissive or partially optically transmissive. Slag materials that are partially optically absorbent or translucent to the laser energy can absorb enough laser energy from the laser 20, 20′, 20″ to remain molten and simultaneously transmit enough laser energy to melt the metal powder and fuse to the underlying substrate. Such slag materials are disclosed in U.S. Patent Application Publication No. US 2014/0220374 A1 published on 7 Aug. 2014, which is incorporated by reference herein. Slag materials may include the following characteristics:

1. molten at temperatures less than the melting point of the metal alloy (for example less than 1260° C.);

2. at least partially optically transmissive to the laser wavelength to absorb enough laser energy to remain molten;

3. shields the molten metal from reaction with air;

4. is non-reactive with air unless an over-shield of inert gas provides such protection.

Materials that meet these requirements include at least some materials used to make fibers, lenses, and windows for metalworking lasers, as well as phosphate and silicate glasses. Examples are listed below:

| Laser Type | Slag Material | Slag Melt Temp. (C.) |
|---|---|---|
| carbon dioxide | germanium | 938 |
| ytterbium fiber | phosphate glass (Pb + Fe) | 900 |
| ytterbium fiber | phosphate glass (Na + Al) | 1100 |
| ytterbium fiber | borosilicate glasses | 1200-1500 |

Additionally, the powdered flux 14″ may be formulated to compensate for loss of volatilized or reacted elements during processing or to actively contribute elements to the deposited metals 38, 58 that are not otherwise contained in alloy particles 14′. Such vectoring agents include titanium, zirconium, boron and aluminum containing compounds and materials such as titanium alloys (Ti), titanium oxide (TiO₂), titanite (CaTiSiO₅), aluminum alloys (Al), aluminum carbonate (Al₂(CO₃)₃), dawsonite (NaAl(CO₃)(OH)₂), borate minerals (e.g., kernite, borax, ulexite, colemanite), nickel titanium alloys (e.g., Nitinol), niobium oxides (NbO, NbO₂, Nb₂O₅) and other metal-containing compounds and materials used to supplement molten alloys with elements. Certain oxometallates as described below can also be useful as vectoring agents.

Flux compositions contained in powdered fluxes 14″ of the present disclosure may include one or more inorganic compound selected from metal oxides, metal halides, metal oxometallates and metal carbonates. Such compounds may function as (i) optically transmissive vehicles; (ii) viscosity/fluidity enhancers; (iii) shielding agents; (iv) scavenging agents; and/or (v) vectoring agents.

Suitable metal oxides include compounds such as Li₂O, BeO, B₂O₃, B₆O, MgO, Al₂O₃, SiO₂, CaO, Sc₂O₃, TiO, TiO₂, Ti₂O₃, VO, V₂O₃, V₂O₄, V₂O₅, Cr₂O₃, CrO₃, MnO, MnO₂, Mn₂O₃, Mn₃O₄, FeO, Fe₂O₃, Fe₃O₄, CoO, Co₃O₄, NiO, Ni₂O₃, Cu₂O, CuO, ZnO, Ga₂O₃, GeO₂, As₂O₃, Rb₂O, SrO, Y₂O₃, ZrO₂, NiO, NiO₂, Ni₂O₅, MoO₃, MoO₂, RuO₂, Rh₂O₃, RhO₂, PdO, Ag₂O, CdO, In₂O₃, SnO, SnO₂, Sb₂O₃, TeO₂, TeO₃, Cs₂O, BaO, HfO₂, Ta₂O₅, WO₂, WO₃, ReO₃, Re₂O₇, PtO₂, Au₂O₃, La₂O₃, CeO₂, Ce₂O₃, and mixtures thereof, to name a few.

Suitable metal halides include compounds such as LiF, LiCI, LiBr, LiI, Li₂NiBr₄, Li₂CuCl₄, LiAsF₆, LiPF₆, LiAICl₄, LiGaCl₄, Li₂PdCl₄, NaF, NaCl, NaBr, Na₃AlF₆, NaSbF₆, NaAsF₆, NaAuBr₄, NaAlCl₄, Na₂PdCl₄, Na₂PtCl₄, MgF₂, MgCl₂, MgBr₂, AlF₃, KCl, KF, KBr, K₂RuCl₅, K₂IrCl₆, K₂PtCl₆, K₂PtCl₆, K₂ReCl₆, K₃RhCl₆, KSbF₆, KAsF₆, K₂NiF₆, K₂TiF₆, K₂ZrF₆, K₂Ptl₆, KAuBr₄, K₂PdBr₄, K₂PdCl₄, CaF₂, CaF, CaBr₂, CaCl₂, Cal₂, ScBr₃, ScCl₃, ScF₃, ScI₃, TiF₃, VCl₂, VCl₃, CrCl₃, CrBr₃, CrCl₂, CrF₂, MnCl₂, MnBr₂, MnF₂, MnF₃, MnI₂, FeBr₂, FeBr₃, FeCl₂, FeCl₃, FeI₂, CoBr₂, CoCl₂, CoF₃, CoF₂, CoI₂, NiBr₂, NiCl₂, NiF₂, NiI₂, CuBr, CuBr₂, CuCl, CuCl₂, CuF₂, CuI, ZnF₂, ZnBr₂, ZnCl₂, ZnI₂, GaBr₃, Ga₂Cl₄, GaCl₃, GaF₃, GaI₃, GaBr₂, GeBr₂, GeI₂, GeI₄, RbBr, RbCl, RbF, RbI, SrBr₂, SrCl₂, SrF₂, SrI₂, YCl₃, YF₃, YI₃, YBr₃, ZrBr₄, ZrCl₄, ZrI₂, YBr, ZrBr₄, ZrCl₄, ZrF₄, ZrI₄, NbCl₅, NbF₅, MoCl₃, MoCl₅, RuI₃, RhCl₃, PdBr₂, PdCl₂, PdI₂, AgCl, AgF, AgF₂, AgSbF₆, AgI, CdBr₂, CdCl₂, CdI₂, InBr, InBr₃, InCl, InCl₂, InCl₃, InF₃, InI, InI₃, SnBr₂, SnCl₂, SnI₂, SnI₄, SnCl₃, SbF₃, SbI₃, CsBr, CsCl, CsF, CsI, BaCl₂, BaF₂, BaI₂, BaCoF₄, BaNiF₄, HfCl₄, HfF₄, TaCl₅, TaF₅, WCl₄, WCl₆, ReCl₃, ReCl₅, IrCl₃, PtBr₂, PtCl₂, AuBr₃, AuCl, AuCl₃, AuI, KAuCl₄, LaBr₃, LaCl₃, LaF₃, LaI₃, CeBr₃, CeCl₃, CeF₃, CeF₄, CeI₃, and mixtures thereof, to name a few.

Suitable oxometallates include compounds such as LiIO₃, LiBO₂, Li₂SiO₃, LiClO₄, Na₂B₄O₇, NaBO₃, Na₂SiO₃, NaVO₃, Na₂MoO₄, Na₂SeO₄, Na₂SeO₃, Na₂TeO₃, K₂SiO₃, K₂CrO₄, K₂Cr2O₇, CaSiO₃, BaMnO₄, and mixtures thereof, to name a few.

Suitable metal carbonates include compounds such as Li₂CO₃, Na₂CO₃, NaHCO₃, MgCO₃, K₂CO₃, CaCO₃, Cr₂(CO₃)₃, MnCO₃, CoCO₃, NiCO₃, CuCO₃, Rb₂CO₃, SrCO₃, Y₂(CO3)₃, Ag₂CO₃, CdCO₃, In₂(CO₃)₃, Sb₂(CO₃)₃, C₂CO₃, BaCO₃, La₂(CO₃)₃, Ce₂(CO₃)₃, NaAl(CO₃)(OH)₂, and mixtures thereof, to name a few.

Optically transmissive vehicles include metal oxides, metal salts and metal silicates such as alumina (Al₂O₃), silica (SiO₂), zirconium oxide (ZrO₂), sodium silicate (Na₂SiO₃), potassium silicate (K₂SiO₃), phosphate glasses (Pb+Fe, Na+Al), borosilicate glasses, certain metalloids (e.g., germanium), and other compounds capable of optically transmitting laser energy (e.g., as generated from NdYAG, CO₂ and Yt fiber lasers).

Viscosity/fluidity enhancers include metal fluorides such as calcium fluoride (CaF₂), cryolite (Na₃AlF₆) and other agents known to enhance viscosity and/or fluidity (e.g., reduced viscosity with CaO, MgO, Na₂O, K₂O and increasing viscosity with Al₂O₃ and TiO₂) in welding applications.

Shielding agents include metal carbonates such as calcium carbonate (CaCO₃), aluminum carbonate (Al₂(CO₃)₃), dawsonite (NaAl(CO₃)(OH)₂), dolomite (CaMg(CO₃)₂), magnesium carbonate (MgCO₃), manganese carbonate (MnCO₃), cobalt carbonate (CoCO₃), nickel carbonate (NiCO₃), lanthanum carbonate (La₂(CO3)₃) and other agents known to form shielding and/or reducing gases (e.g., CO, CO₂, H₂).

Scavenging agents include metal oxides and fluorides such as calcium oxide (CaO), calcium fluoride (CaF₂), iron oxide (FeO), magnesium oxide (MgO), manganese oxides (MnO, MnO₂), niobium oxides (NbO, NbO₂, Nb₂O₅), titanium oxide (TiO₂), zirconium oxide (ZrO₂) and other agents known to react with detrimental elements such as sulfur and phosphorous to form low-density byproducts expected to “float” into a resulting slag layer 42, 52.

Vectoring agents include titanium, zirconium, boron and aluminum containing compounds and materials such as titanium alloys (Ti), titanium oxide (TiO₂), titanite (CaTiSiO₅), aluminum alloys (Al), aluminum carbonate (Al₂(CO₃)₃), dawsonite (NaAl(CO₃)(OH)₂), borate minerals (e.g., kernite, borax, ulexite, colemanite), nickel titanium alloys (e.g., Nitinol), niobium oxides (NbO, NbO₂, Nb₂O₅) and other metal-containing compounds and materials used to supplement molten alloys with elements.

In some embodiments the powdered flux 14″ may also contain certain organic fluxing agents. Examples of organic compounds exhibiting flux characteristics include high-molecular weight hydrocarbons (e.g., beeswax, paraffin), carbohydrates (e.g., cellulose), natural and synthetic oils (e.g., palm oil), organic reducing agents (e.g., charcoal, coke), carboxylic acids and dicarboxylic acids (e.g., abietic acid, isopimaric acid, neoabietic acid, dehydroabietic acid, rosins), carboxylic acid salts (e.g., rosin salts), carboxylic acid derivatives (e.g., dehydro-abietylamine), amines (e.g., triethanolamine), alcohols (e.g., high polyglycols, glycerols), natural and synthetic resins (e.g., polyol esters of fatty acids), mixtures of such compounds, and other organic compounds.

In some embodiments the powdered flux contains:

5-60% by weight of metal oxide(s);

10-70% by weight of metal fluoride(s);

5-40% by weight of metal silicate(s); and

0-40% by weight of metal carbonate(s),

based on a total weight of the powdered flux.

In some embodiments the powdered flux contains:

5-40% by weight of Al₂O₃, SiO₂, and/or ZrO₂;

10-50% by weight of metal fluoride(s);

5-40% by weight of metal silicate(s);

0-40% by weight of metal carbonate(s); and

15-30% by weight of other metal oxide(s),

based on a total weight of the powdered flux.

In some embodiments powdered flux contains:

5-60% by weight of at least one of Al₂O₃, SiO₂, Na₂SiO₃ and K₂SiO₃;

10-50% by weight of at least one of CaF₂, Na₃AlF₆, Na₂O and K₂O;

1-30% by weight of at least one of CaCO₃, Al₂(CO₃)₃, NaAl(CO₃)(OH)₂, CaMg(CO₃)₂, MgCO₃, MnCO₃, CoCO₃, NiCO₃ and La₂(CO3)₃;

15-30% by weight of at least one of CaO, MgO, MnO, ZrO₂ and TiO₂; and

0-5% by weight of at least one of a Ti metal, an Al metal and CaTiSiO₅,

based on a total weight of the powdered flux.

In some embodiments the powdered flux contains:

5-40% by weight of Al₂O₃;

10-50% by weight of CaF₂;

5-30% by weight of SiO₂;

1-30% by weight of at least one of CaCO₃, MgCO₃ and MnCO₃;

15-30% by weight of at least two of CaO, MgO, MnO, ZrO₂ and TiO₂; and

0-5% by weight of at least one of Ti, Al, CaTiSiO₅, Al₂(CO₃)₃ and NaAl(CO₃)(OH)₂,

based on a total weight of the powdered flux.

In some embodiments the powdered flux contains at least two compounds selected from a metal oxide, a metal halide, an oxometallate and a metal carbonate. In other embodiments the powdered flux contains at least three of a metal oxide, a metal halide, an oxometallate and a metal carbonate. In still other embodiments the powdered flux may contain a metal oxide, a metal halide, an oxometallate and a metal carbonate.

Viscosity of the molten slag may be increased by including at least one high melting-point metal oxide which can act as thickening agent. Thus, in some embodiments the powdered flux is formulated to include at least one high melting-point metal oxide. Examples of high melting-point metal oxides include metal oxides having a melting point exceeding 2000° C.—such as Sc₂O₃, Cr₂O₃, Y₂O₃, ZrO₂, HfO₂, La₂O₃, Ce₂O₃, Al₂O₃ and CeO₂.

In some embodiments the powdered flux of the present disclosure contains zirconia (ZrO₂) and at least one metal silicate, metal fluoride, metal carbonate, metal oxide (other than zirconia), or mixtures thereof. In such cases the content of zirconia is often greater than about 7.5 percent by weight, and often less than about 25 percent by weight. In other cases the content of zirconia is greater than about 10 percent by weight and less than 20 percent by weight. In still other cases the content of zirconia is greater than about 3.5 percent by weight, and less than about 15 percent by weight. In still other cases the content of zirconia is between about 8 percent by weight and about 12 percent by weight.

In some embodiments the powdered flux contains a metal carbide and at least one metal oxide, metal silicate, metal fluoride, metal carbonate, or mixtures thereof. In such cases the content of the metal carbide is less than about 10 percent by weight. In other cases the content of the metal carbide is equal to or greater than about 0.001 percent by weight and less than about 5 percent by weight. In still other cases the content of the metal carbide is greater than about 0.01 percent by weight and less than about 2 percent by weight. In still other cases the content of the metal carbide is between about 0.1 percent and about 3 percent by weight.

In some embodiments the powdered flux contains at least two metal carbonates and at least one metal oxide, metal silicate, metal fluoride, or mixtures thereof. For example, in some instances the powdered flux contains calcium carbonate (for phosphorous control) and at least one of magnesium carbonate and manganese carbonate (for sulfur control). In other cases the powdered flux contains calcium carbonate, magnesium carbonate and manganese carbonate. Some flux compositions comprise a ternary mixture of calcium carbonate, magnesium carbonate and manganese carbonate such that a proportion of the ternary mixture is equal to or less than 30% by weight relative to a total weight of the flux material. A combination of such carbonates (binary or ternary) is beneficial in most effectively scavenging multiple tramp elements.

All of the percentages (%) by weight enumerated above are based upon a total weight of the flux material being 100%.

Commercially availed fluxes may be also used to form composite materials of the present disclosure. Examples includes flux materials sold under the names Lincolnweld P2007, Bohler Soudokay NiCrW-412, ESAB OK 10.16 and 10.90, Special Metals NT100, Oerlikon OP76, Bavaria WP 380, Sandvik 50SW, 59S or SAS1, and Avesta 805. Such commercial fluxes may be ground to a smaller particle size range before use.

Together, these process steps produce crack-free deposits of superalloy deposits or cladding on superalloy substrates at room temperature for materials that heretofore were believed only to be joinable with a hot box process or through the use of a chill plate. Inasmuch as the flux material 14″ is fluidized with the powdered metal 14′ and when heated and melted forms a layer of slag 42, 52, more expensive inert gases are not required to fluidize the bed of powdered material 14. Indeed, compressed air may be used to fluidize the bed of powdered material.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. An additive manufacturing apparatus, comprising:
a chamber;
a bed of powdered material including powdered metal material in the chamber;
an energy beam that selectively scans portions of a processing plane of the bed of powdered material to heat and melt the powdered material which solidifies to form a metal deposit layer; and
one or more variable masking elements disposed between a source of the energy beam and the processing plane of the bed of powdered material, the one or more masking elements comprising one or more optically transmissive portions that define a pattern of the energy beam at the bed processing plane;
wherein the one or more masking elements are operable to change the energy beam pattern at the bed processing plane according to a predetermined shape of a component to be formed or repaired.

2. The apparatus of claim 1, wherein the one or more masking elements includes a plurality of masking elements aligned side by side, disposed in the same plane and at least some of the masking elements are moveable in at least one direction according to the predetermined shape of the component.

3. The apparatus of claim 1, wherein the one or more masking elements includes a plurality of masking elements wherein a first masking element is disposed underneath a second masking element.

4. The apparatus of claim 3, wherein the first masking element includes an array of optically transmissive portions and the second masking element includes a second array of optically transmissive portions, and the first and second masking elements are moveable relative to one another according to the predetermined shape of the component.

5. The apparatus of claim 1, wherein the chamber is in fluid communication with a fluidizing medium introduced into the chamber to fluidize the bed of powdered material.

6. The apparatus of claim 1, wherein the powdered material also includes a powdered flux material.

7. The apparatus of claim 1, further comprising a vibratory device adapted to apply mechanical vibratory energy to the component.

8. The apparatus of claim 1, further comprising a platen on which the component is formed or repaired and the platen is moveable vertically downward relative to the processing plane of the bed of powdered material.

9. The apparatus of claim 1, wherein the one or more masking elements comprising a single mask that is moveable to change the pattern of the beam at the processing plane of the bed according to a predetermined shape of the component.

10. An additive manufacturing process, comprising:
providing a bed of powdered material comprising powdered metal material;
heating portions of the bed of powdered material with an energy beam along a processing plane of the bed to form a metal deposit layer;
providing one or more masking elements between the processing plane of the bed of powdered material and a source of the energy beam, the one or more masking elements comprising one or more optically transmissive portions that define a pattern of the energy beam at the bed processing plane; and
selectively changing the masking elements and resulting energy beam pattern at the bed processing plane according to a predetermined shape of a component to be formed or repaired.

11. The process of claim 10, wherein the one or more masking elements includes a plurality of masking elements aligned side by side within a plane and the changing of the masking elements includes moving at least one of the masking elements in one or more directions within the plane.

12. The process of claim 10, wherein the one or more masking elements includes a plurality of masking elements wherein a first masking element having one or more first optically transmissive portions is disposed underneath a second masking element having one or more second optically transmissive portions and the changing of the masking elements includes aligning the first optically transmissive portions relative to the second optically transmissive portions to change the beam pattern at the processing plane according to the predetermined shape of the component.

13. The process of claim 10, wherein the metal deposit layer is formed or repaired on a platen and the process further comprises moving the platen vertically downward to form the component.

14. The process of claim 13, wherein the powdered material further comprises a powdered flux material.

15. The process of claim 14, further comprising fluidizing the bed of powdered material by introducing a fluidizing medium into the bed of powdered material.

16. The process of claim 14, wherein the powdered flux material comprises at least two compounds selected from the group consisting of a metal oxide, a metal halide, an oxometallate and a metal carbonate.

17. The process of claim 10, wherein the one or more masking elements comprises a single mask that is moveable to change the pattern of the beam at the processing plane of the bed according to a predetermined shape of the component.

18. The process of claim 10, further comprising vibrating the component with a vibratory device to induce spreading of the powdered material over a surface of the component.

19. An additive manufacturing process, comprising:
providing a bed of powdered material comprising powdered metal material;
fluidizing the bed of powdered metal material; and
selectively heating portions of the bed of powdered material with an energy beam along a processing plane of the bed to form a metal deposit layer on a component;
wherein a portion of the component extends above the processing plane and a portion of the component to be formed or repaired is below or at the processing bed of the fluidized bed of powdered material.

20. The process of claim 19, further comprising:
providing one or more masking elements between the processing plane of the bed of powdered material and a source of the energy beam, and the one or more masking elements comprising one or more optically transmissive portions that define a pattern of the energy beam at the bed processing plane; and,
selectively changing the beam pattern at the bed processing plane by changing the masking elements according to a predetermined shape of the component to be formed or repaired.
